(19) United States
(12) Patent Application Publication
(10) Pub. No.: US 2023/0259318 A1
(43) Pub. Date: Aug. 17, 2023

(54) INFORMATION PROCESSING DEVICE AND VEHICLE SYSTEM

(71) Applicant: TOYOTA JIDOSHA KABUSHIKI KAISHA, Toyota-shi (JP)

(72) Inventors: Ryogo NONAKA, Kawasaki-shi (JP); Hirona OTA, Seto-shi (JP); Yuki TATSUMOTO, Seto-shi (JP); Tsunehiro YOKOMORI, Toyota-shi (JP)

(73) Assignee: TOYOTA JIDOSHA KABUSHIKI KAISHA, Toyota-shi (JP)

(21) Appl. No.: 18/155,938

(22) Filed: Jan. 18, 2023

(30) Foreign Application Priority Data
Feb. 15, 2022 (JP) 2022-021642

(51) Int. Cl. G06F 3/14; G06F 3/0488; G09F 9/30; G06Q 10/02

(52) U.S. Cl. CPC G06F 3/14; G06F 3/0488; G06Q 10/02; G09F 9/30

(57) ABSTRACT

An information processing device includes a controller configured to acquire first data about a vehicle cabin situation from a vehicle that is a fixed-route bus, and output a guidance image generated based on the first data via a signage device installed at a bus stop at which the vehicle stops.

### CROSS-REFERENCE TO RELATED APPLICATION

This application claims priority to Japanese Patent Application No. 2022-021642 filed on Feb. 15, 2022, incorporated herein by reference in its entirety.

### BACKGROUND

### 1. Technical Field

The present disclosure relates to an information processing device and a vehicle system.

### 2. Description of Related Art

Attempts are being made to install digital signages at bus stops to provide information. By using digital signages, it is possible to transmit information such as bus arrival times and operation information in real time. In this regard, for example, Japanese Unexamined Patent Application Publication No. 2020-060870 discloses a signage device capable of providing traffic information and disaster information in addition to operation information.

### SUMMARY

The present disclosure provides an information processing device and a vehicle system that efficiently provide information on fixed-route buses.

An information processing device according to a first aspect of the present disclosure includes a controller configured to acquire first data about a vehicle cabin situation from a vehicle that is a fixed-route bus and output a guidance image generated based on the first data via a signage device installed at a bus stop at which the vehicle stops.

In the first aspect, the first data may include information on a seat occupancy situation or passenger distribution in the vehicle.

In the first aspect, the controller may output, via the signage device, an image obtained by visualizing the vehicle cabin situation based on the first data.

In the first aspect, the controller may output the guidance image corresponding to the vehicle designated by a user when the first data is acquired from a plurality of vehicles.

In the first aspect, the controller may output the guidance image corresponding to the vehicle via the signage device installed at a bus stop to which the vehicle approaches so as to be within a predetermined distance.

In the first aspect, the controller may output the guidance image corresponding to the vehicle via the signage device installed at a bus stop at which the vehicle arrives within a predetermined time.

In the first aspect, the controller may acquire information on a passenger boarding at the bus stop via a touch panel of the signage device.

In the first aspect, the controller may transmit the information on the passenger to an in-vehicle device mounted on the vehicle.

In the first aspect, the information on the passenger may include whether the passenger uses a stroller or a wheelchair.

In the first aspect, the information on the passenger may include a request to reserve a seat.

In the first aspect, the controller may acquire the request via the touch panel of the signage device.

In the first aspect, the controller may acquire the request from a user terminal.

A vehicle system according to a second aspect of the present disclosure includes a first device and a second device. The first device is mounted on a vehicle that is a fixed-route bus. A second device is configured to control a signage device installed at a bus stop. The first device has a first controller configured to transmit first data about a vehicle cabin situation to the second device, and the second device has a second controller configured to output a guidance image generated based on the first data via the signage device installed at the bus stop at which the vehicle stops.

In the second aspect, the first device may include a sensor configured to sense a vehicle cabin of the vehicle. The first device may transmit the first data including a result of the sensing to the second device.

In the second aspect, the first data may include information on a seat occupancy situation or passenger distribution in the vehicle.

In the second aspect, the second controller may output, via the signage device, an image obtained by visualizing the vehicle cabin situation based on the first data.

In the second aspect, the second controller may output the guidance image corresponding to the vehicle via the signage device installed at a bus stop to which the vehicle approaches so as to be within a predetermined distance.

In the second aspect, the second controller may acquire information on a passenger boarding at the bus stop via a touch panel of the signage device.

In the second aspect, the second controller may transmit the information on the passenger to the first device.

In the second aspect, the first controller may notify a vehicle cabin of the vehicle regarding the information on the passenger.

Another aspect includes a program for causing a computer to execute the method executed by the device described above, or a computer-readable storage medium that non-transitory stores the program.

With each aspect of the present disclosure, it is possible to efficiently provide information on a fixed-route bus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle system according to a first embodiment;

FIG. 2 is a diagram illustrating components of an in-vehicle device according to the first embodiment;

FIG. 3A is a schematic top view of a vehicle cabin of a bus;

FIG. 3B is a schematic top view of the vehicle cabin of the bus;

FIG. 4 is a diagram for illustrating vehicle data transmitted from a vehicle;

FIG. 5 is a diagram illustrating in detail components of a server device;

FIG. 6 is an example of information output by a signage;

FIG. 7 is an example of guidance data transmitted to the signage;

FIG. 8 illustrates examples of signage data and route data;

FIG. 9 is a diagram illustrating in detail components of the signage;

FIG. 10 is an example of an image generated by the signage;

FIG. 11 is an example of an image generated by the signage;

FIG. 12 is a sequence diagram of processing in which an in-vehicle device transmits the vehicle data to the server device;

FIG. 13 is a sequence diagram of processing in which the server device transmits the guidance data to the signage;

FIG. 14 is a flowchart of processing executed in step S22;

FIG. 15 is a schematic diagram of a vehicle system according to a second embodiment;

FIG. 16 is a diagram illustrating components of a signage in the second embodiment;

FIG. 17 is an example of an interface for inputting passenger information;

FIG. 18 is an example of passenger data generated by an information acquisition unit;

FIG. 19 is a diagram illustrating components of a server device according to the second embodiment;

FIG. 20 is a diagram illustrating components of an in-vehicle device according to the second embodiment;

FIG. 21 is an example of a screen output by operation-related equipment;

FIG. 22 is a schematic diagram of a vehicle system according to a third embodiment;

FIG. 23 is a diagram illustrating components of a server device according to the third embodiment;

FIG. 24 is a diagram illustrating components of a signage in the third embodiment; and

FIG. 25 is an example of an interface for inputting reservation information.

### DETAILED DESCRIPTION OF EMBODIMENTS

A system that provides operation information of fixed-route buses and the like using a digital signage device installed at a bus stop is well-known. The system can acquire and display information such as the destination of the bus, the waypoint, and the arrival time in real time.

On the other hand, the systems of the related art have an issue in that they cannot transmit detailed information about arriving buses. For example, information such as “the next bus is crowded, so you should wait for the bus after that” cannot be presented. Although there are attempts to acquire the degree of crowding for each vehicle, it is not possible to obtain specific information such as an answer to the question, “Does the next arriving bus have enough space for a baby stroller?”

An information processing device according to an aspect of the present disclosure includes a control unit that acquires first data about a vehicle cabin situation from a vehicle that is a fixed-route bus and outputs a guidance image generated based on the first data via a signage device installed at a bus stop at which the vehicle stops.

A fixed-route bus is a passenger vehicle that operates on a predetermined route according to a predetermined schedule. The information processing device is, for example, a computer that controls a signage device installed at a bus stop. The information processing device may manage a plurality of signage devices installed at a plurality of bus stops. The control unit acquires data about the vehicle cabin situation of a predetermined vehicle in operation, and outputs a guidance image generated based on the data via the signage device. The guidance image may be generated by the information processing device, or the information processing device may cause the signage device to generate the guidance image. Examples of data about the vehicle cabin situation include data indicating the degree of crowding, seating situations, and distribution of people (which seats or standing spots in the vehicle are occupied). The guidance image visualizes this data. This allows passengers waiting at the bus stop to accurately grasp the vehicle cabin situation of the arriving bus.

When a plurality of buses arrive at the bus stop within a predetermined period of time, it may be possible to select which vehicle information is to be displayed on the signage device. The control unit may output a guidance image corresponding to the selected vehicle.

Furthermore, the control unit may acquire information on passengers boarding the bus at the bus stop via the signage device and transmit this to the inside of the bus. As a result, for example, it is possible to notify the inside of the bus in advance that a disabled person, a stroller, a wheelchair, or the like will board the bus. In addition, by informing the inside of the bus of this, it is possible to prepare a boarding space in advance.

Further, when a target bus is a bus having a maximum seating capacity, seat reservations may be accepted based on the data acquired via the signage device. This allows passengers to reserve seats even when they do not have a terminal.

Hereinafter, specific embodiments of the present disclosure will be described based on the drawings. The hardware configurations, module configurations, functional configurations, and the like described in each embodiment are not intended to limit the technical scope of the disclosure thereto unless otherwise specified.

### First Embodiment

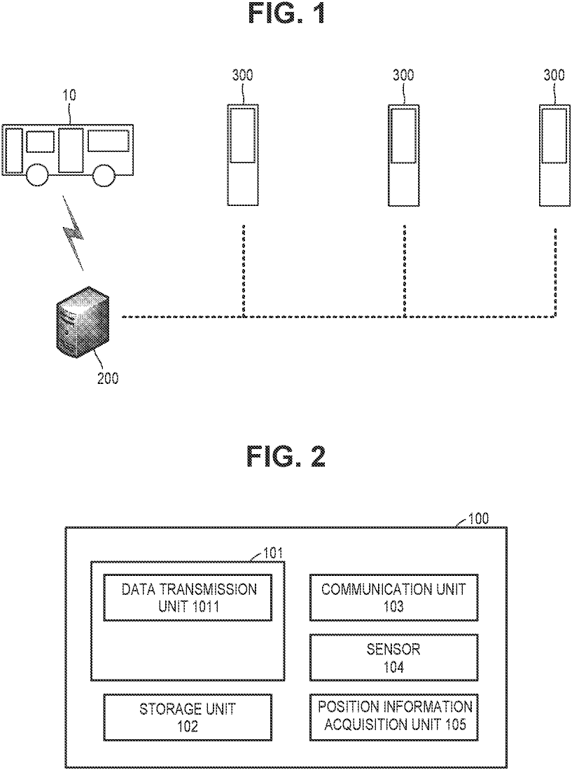

An overview of a vehicle system according to a first embodiment will be described with reference to FIG. 1. The vehicle system according to the present embodiment includes a vehicle 10 in which an in-vehicle device 100 is mounted, a server device 200, and a plurality of signages 300. A plurality of vehicles 10 (in-vehicle devices 100) and signages 300 may be included in the system.

The vehicle 10 is a fixed-route bus vehicle equipped with the in-vehicle device 100. The vehicle 10 travels along a predetermined route according to a predetermined schedule. The in-vehicle device 100 is configured to be able to wirelessly communicate with the server device 200. The signage 300 is installed at a bus stop through which the vehicle 10 passes, and is a device that displays images using a display, a projector, or the like. By using the signage 300, it becomes possible to provide the arrival time and operation information of the vehicle 10 to passengers waiting for the arrival of the bus. The signage 300 may have a function of outputting voice and a function of acquiring input.

The server device 200 is a device that receives vehicle-related data from the vehicles 10 (in-vehicle devices 100) and generates data to be output to the signage 300 based on the data. The server device 200 receives data from the vehicles 10 (in-vehicle devices 100) under management and stores the data in a database. In addition, based on the stored data, data to be provided to each of the signages 300 is generated and delivered to each signage at a predetermined time. The signage 300 provides information based on the received data. This makes it possible to provide passengers waiting at the bus stop with the status of the bus in operation.

The server device 200 may be configured to be able to further provide general information regarding bus operation to the signage 300. Such information can be obtained, for example, from a traffic information server operated by a bus company.

Each element that configures the system will be described. The vehicle 10 is a vehicle that travels as a fixed-route bus, and is a connected car that has a function of communicating with an external network. The vehicle 10 is equipped with the in-vehicle device 100.

The in-vehicle device 100 is a computer mounted on a fixed-route bus. The in-vehicle device 100 is mounted for the purpose of transmitting information about a subject vehicle, and transmits various types of information including position information to the server device 200 via a wireless network. The in-vehicle device 100 may also serve as a device that provides information to the crew or passengers of the bus. For example, the in-vehicle device 100 may be a piece of equipment (hereinafter referred to as operation-related equipment) that provides operation guidance to passengers. Examples of operation-related equipment include a piece of equipment that controls a destination display device and a broadcasting device that the vehicle 10 has. In addition, the in-vehicle device 100 may be an electronic control unit (ECU) that a vehicle platform has. Further, the in-vehicle device 100 may be a data communication module (DCM) having a communication function. The in-vehicle device 100 has a function of wirelessly communicating with an external network. The in-vehicle device 100 may have a function of downloading traffic information, road map data, and the like by communicating with an external network.

The in-vehicle device 100 can be configured by a general-purpose computer. That is, the in-vehicle device 100 can be configured as a computer having a processor such as a CPU or a GPU, a main storage device such as a RAM or a ROM, an auxiliary storage device such as an EPROM, a hard disk drive, or a removable medium. The auxiliary storage device stores an operating system (OS), various programs, various tables, and the likes, and by executing the programs stored therein, it is possible to realize each function that meets a predetermined purpose, as will be described below. However, some or all of the functions may be realized by hardware circuits such as ASIC and FPGA.

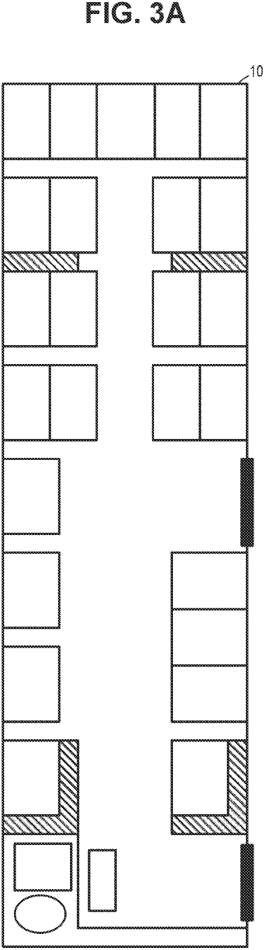

FIG. 2 is a diagram illustrating in detail the components of the in-vehicle device 100 mounted on the vehicle 10. The in-vehicle device 100 includes a control unit 101, a storage unit 102, a communication unit 103, a sensor 104, and a position information acquisition unit 105.

The control unit 101 is an arithmetic unit that realizes various functions of the in-vehicle device 100 by executing a predetermined program. The control unit 101 may be realized by a CPU or the like. The control unit 101 is configured with a data transmission unit 1011 as a functional module. The functional modules may be realized by executing stored programs with the CPU.

The data transmission unit 1011 acquires or generates data about the subject vehicle at a predetermined time via the sensor 104 and the position information acquisition unit 105 described below, and transmits the data to the server device 200. In the present embodiment, the data about the subject vehicle includes the following two types of data.
(1) Data about operation
(2) Data obtained by sensing the vehicle cabin

Data (hereinafter referred to as operation-related data) about operation includes, for example, the route in operation (for example, line number), destination, and current travel position (between which bus stops the vehicle is traveling). The operation-related data may be obtained from on-vehicle operation-related equipment such as equipment that controls a guidance broadcast, or a destination display.

Data (hereinafter referred to as vehicle cabin data) obtained by sensing the vehicle cabin is data representing the situation of the vehicle cabin. In the present embodiment, the distribution of passengers in the vehicle cabin is acquired as the situation of the vehicle cabin.

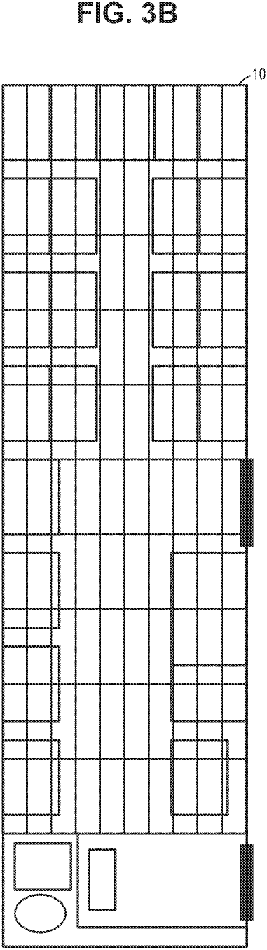

The distribution of passengers will be described. The in-vehicle device 100 according to the present embodiment senses where in the vehicle the passengers are located by the sensor 104 mounted on the vehicle. FIG. 3A is a schematic top view of the vehicle cabin of the bus. The bus shown in this example has 25 seats for passengers. When the sensor 104 is a seating sensor installed in the seat, the data transmission unit 1011 can determine which seat a passenger is sitting in. In this case, it is possible to acquire the presence or absence of passengers for each seat.

In addition, when the sensor 104 is an image sensor that captures images of the vehicle cabin, it can also capture the position of standing passengers. For example, as illustrated in FIG. 3B, it is possible to divide the vehicle cabin into a plurality of grids and determine whether each grid includes a person based on the image. Further, the sensor 104 may include a weight sensor installed on the floor of the vehicle 10. In this case, it is possible to determine whether each grid includes a person based on the weight corresponding to each grid.

The data transmission unit 1011 generates vehicle cabin data (for example, bitmap data representing the distribution of people in the vehicle cabin) and transmits it to the server device 200 together with the operation-related data. The operation-related data and the vehicle cabin data are collectively referred to as “vehicle data”.

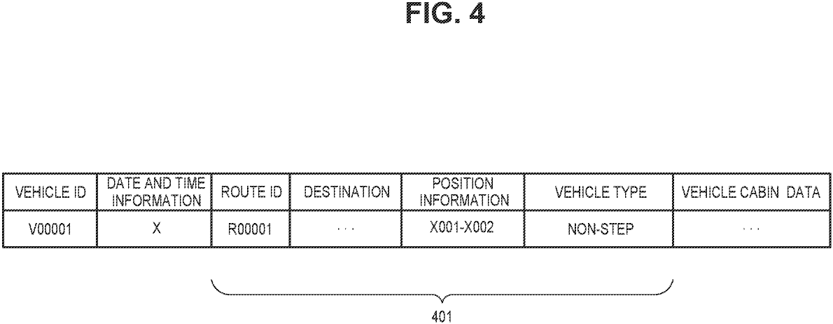

FIG. 4 is an example of vehicle data. A field indicated by reference numeral 401 corresponds to operation-related data. The vehicle data includes fields of vehicle ID, date and time information, route ID, destination, position information, vehicle information, and vehicle cabin data. The vehicle ID field stores an identifier that uniquely identifies the vehicle. The date and time information field stores the date and time when the vehicle data was generated. The route ID and destination fields store identifiers of routes and destinations on which the vehicle 10 travels. The position information field stores the section in which the vehicle 10 is currently travelling. The position information may be represented by latitude and longitude, or may be represented by a bus stop ID, for example. The position information may be information such as “traveling between bus stops X1 and X2”. The position information can be acquired via the position information acquisition unit 105, which will be described below. In addition, the position information may be acquired from the operation-related equipment described above. For example, the section in which the vehicle is traveling may be determined based on the data acquired from the operation-related equipment. Information on the vehicle 10 is stored in the vehicle information field. Information on the vehicle 10 may be, for example, information about the type (non-step bus or the like) of the vehicle 10, or information about facilities (wheelchair space, wheelchair ramp, or the like) of the vehicle 10.

The storage unit 102 is a means for storing information, and is composed of a storage medium such as a RAM, a magnetic disk, or a flash memory. The storage unit 102 stores various programs executed by the control unit 101, data used by the programs, and the like.

The communication unit 103 includes an antenna and a communication module for wireless communication. An antenna is an antenna element that inputs and outputs radio signals. In the present embodiment, the antenna is adapted for mobile communications (for example, mobile communications such as 3G, LTE, and 5G). The antenna may be configured to include a plurality of physical antennas. For example, when performing mobile communication using radio waves in a high frequency band such as microwaves and millimeter waves, a plurality of antennas may be distributed and arranged in order to stabilize communication. A communication module is a module for performing mobile communication.

The sensor 104 is one or more sensors for acquiring the vehicle cabin data described above. The sensor 104 can include, for example, a sensor for detecting whether a person is seated on a seat, a weight sensor installed on the floor, and an image sensor (visible light image sensor, distance image sensor, infrared image sensor) for detecting distribution of people in the vehicle cabin. The sensor 104 may be another sensor as long as it can detect the distribution of people in the vehicle cabin.

The position information acquisition unit 105 includes a GPS antenna and a positioning module for acquiring position information. A GPS antenna is an antenna that receives positioning signals transmitted from positioning satellites (also called GNSS satellites). A positioning module is a module that calculates position information based on signals received by a GPS antenna.

Next, the server device 200 will be described. The server device 200 is a device that collects vehicle data from the vehicles 10 (in-vehicle devices 100) and provides guidance via the signage 300 based on the collected vehicle data.

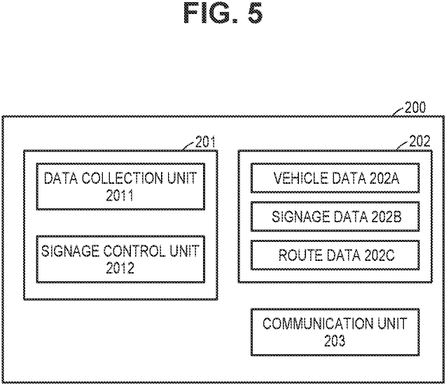

FIG. 5 is a diagram illustrating in detail the components of the server device 200 included in the vehicle system according to the present embodiment.

The server device 200 can be configured with a general-purpose computer. That is, the server device 200 can be configured as a computer having a processor such as a CPU or a GPU, a main storage device such as a RAM or a ROM, an auxiliary storage device such as an EPROM, a hard disk drive, or a removable medium. The auxiliary storage device stores an operating system (OS), various programs, various tables, and the like, and by loading a program stored in the auxiliary storage device into the work area of the main storage device and executing it, and controlling each component via the execution of the program, as will be described below, it is possible to realize each function that meets a predetermined purpose. However, some or all of the functions may be realized by hardware circuits such as ASIC and FPGA.

The server device 200 is configured with a control unit 201, a storage unit 202, and a communication unit 203. The control unit 201 is an arithmetic unit that controls the server device 200. The control unit 201 can be realized by an arithmetic processing device such as a CPU. The control unit 201 includes a data collection unit 2011 and a signage control unit 2012 as functional modules. Each functional module may be realized by executing a stored program by the CPU.

The data collection unit 2011 collects vehicle data from the vehicles 10 (in-vehicle devices 100), and executes a process of storing, as vehicle data 202A, the collected vehicle data in the storage unit 202, which will be described below.

The signage control unit 2012 controls the signages 300 based on collected vehicle data and pre-stored data about bus stops and signages. Based on this data, the signage control unit 2012 determines the vehicle approaching each bus stop and transmits data (hereinafter referred to as guidance data) to the signage 300 installed at each bus stop so as to output information on the corresponding vehicle.

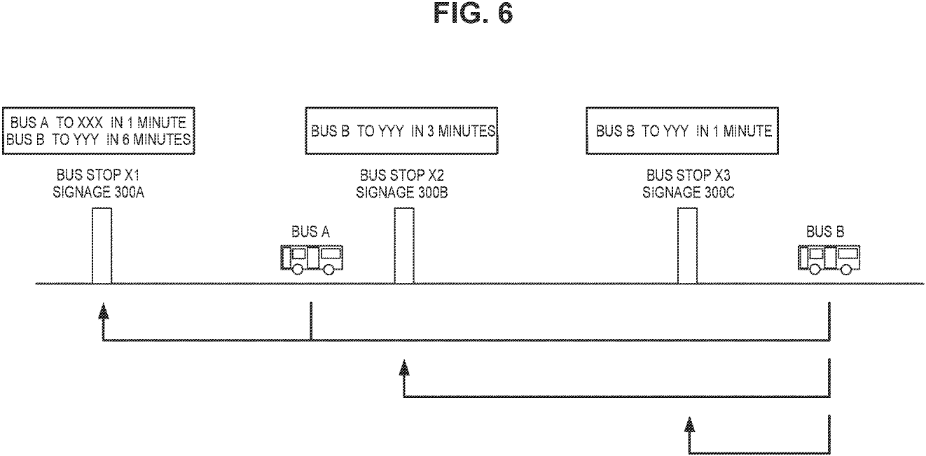

FIG. 6 shows an example in which the signage 300 installed at each bus stop outputs information. Here, a signage installed at a bus stop X1 is indicated by 300A, a signage installed at a bus stop X2 is indicated by 300B, and a signage installed at a bus stop X3 is indicated by 300C in order to distinguish them from each other.

In the illustrated example, a bus A and a bus B are approaching the bus stop X1. The bus B is approaching the bus stops X2 and X3. A bus stop through which a bus traveling on a certain route passes can be determined by referring to pre-stored route-related data (described below).

Here, when there is a rule to “display information about a bus that departed from a bus stop of three stops before at which a passenger boards on the signage 300”, the signage control unit 2012 determines to cause the signage 300A installed at the bus stop X1 to output information about the buses A and B. In addition, the signage control unit 2012 determines to cause the signages 300B and 300C installed at the bus stops X2 and X3 to output information about the bus B.

The signage control unit 2012 then generates data to be transmitted to each signage 300. That is, the signage control unit 2012 executes the following processes (1) to (3).
(1) Based on the vehicle data transmitted from the bus A and the bus B, guidance data to be transmitted to the signage 300A is generated.
(2) Based on the vehicle data transmitted from the bus B, guidance data to be transmitted to the signage 300B is generated.
(3) Based on the vehicle data transmitted from the bus B, guidance data to be transmitted to the signage 300C is generated.

Guidance data includes information output by each signage 300. In the present embodiment, the guidance data is data for causing the signage 300 to generate image data. In the present embodiment, the signage 300 generates and outputs image data based on the guidance data.

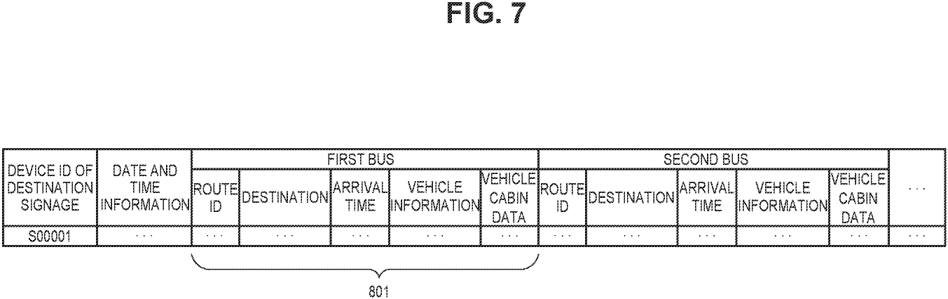

FIG. 7 is an example of guidance data transmitted from the server device 200 to the signage 300. The guidance data includes the identifier of the signage 300, which is the destination of the data, and date and time information. The guidance data includes a set (reference numeral 801) of a route identifier, destination, estimated time of arrival, vehicle information, and vehicle cabin data. The vehicle cabin data may be binary data. Such data is defined on a vehicle-by-vehicle basis. For example, in the illustrated example, data for two vehicles, the vehicle that arrives next and the vehicle that arrives after that, is included.

The storage unit 202 includes a main storage device and an auxiliary storage device. The main storage device is a memory in which programs executed by the control unit 201 and data used by the control program are developed. The auxiliary storage device is a device in which programs executed in the control unit 201 and data used by the control program are stored.

The storage unit 202 stores vehicle data 202A, signage data 202B, and route data 202C. The vehicle data 202A is a set of a plurality of pieces of vehicle data transmitted from the in-vehicle device 100. The vehicle data 202A stores a plurality of pieces of vehicle data described with reference to FIG. 4. The stored vehicle data 202A may be deleted at a predetermined time (for example, at a time when a predetermined period of time has elapsed since the data was received).

The signage data 202B is data relating to the signages 300 installed at the bus stops. In addition, the route data 202C is data relating to the route on which the fixed-route bus under the control of the server device travels.

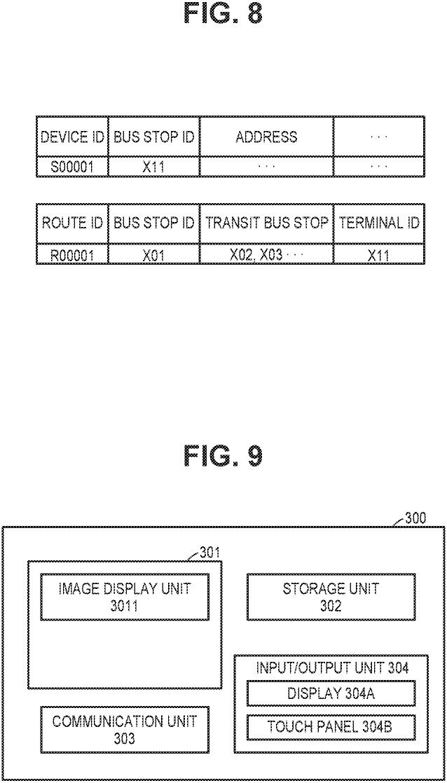

FIG. 8 shows an example of the signage data 202B and the route data 202C. The signage data 202B, which is the data displayed in the upper part of FIG. 8, includes the identifier of the signage 300, the identifier of the bus stop at which the signage is installed, the network address of the signage, and the like. The server device 200 can identify the destination of the guidance data by referring to the signage data 202B. The route data 202C, which is the data displayed in the lower part of FIG. 8, includes the identifier of the route, the identifier of the starting bus stop, the identifier of the bus stop to pass through, the identifier of the terminal bus stop, and the like. By referring to the route data 202C, the server device 200 can identify the bus stop through which any bus passes.

The communication unit 203 is a communication interface for connecting the server device 200 to a network. The communication unit 203 may include, for example, a network interface board and a wireless communication interface for wireless communication.

Next, the signage 300 will be described. The signage 300 is a device that provides guidance to passengers waiting at a bus stop based on guidance data transmitted from the server device 200.

FIG. 9 is a diagram illustrating in detail the components of the signage 300 included in the vehicle system according to the present embodiment.

The signage 300 can be configured as a computer having a processor such as a CPU or a GPU, a main storage device such as a RAM or a ROM, an auxiliary storage device such as an EPROM, a hard disk drive, or a removable medium. However, some or all of the functions may be realized by hardware circuits such as ASIC and FPGA.

The signage 300 includes a control unit 301, a storage unit 302, a communication unit 303, and an input/output unit 304. The control unit 301 is an arithmetic unit that controls the signage 300. The control unit 301 can be realized by an arithmetic processing device such as a CPU. The control unit 301 is configured with an image display unit 3011 as a functional module. The functional modules may be realized by executing stored programs with a CPU.

The image display unit 3011 outputs an image based on guidance data received from the server device 200. In the present embodiment, the image display unit 3011 generates image data based on guidance data and outputs it via the input/output unit 304. Therefore, the image display unit 3011 may execute processing for generating image data according to a predetermined rule.

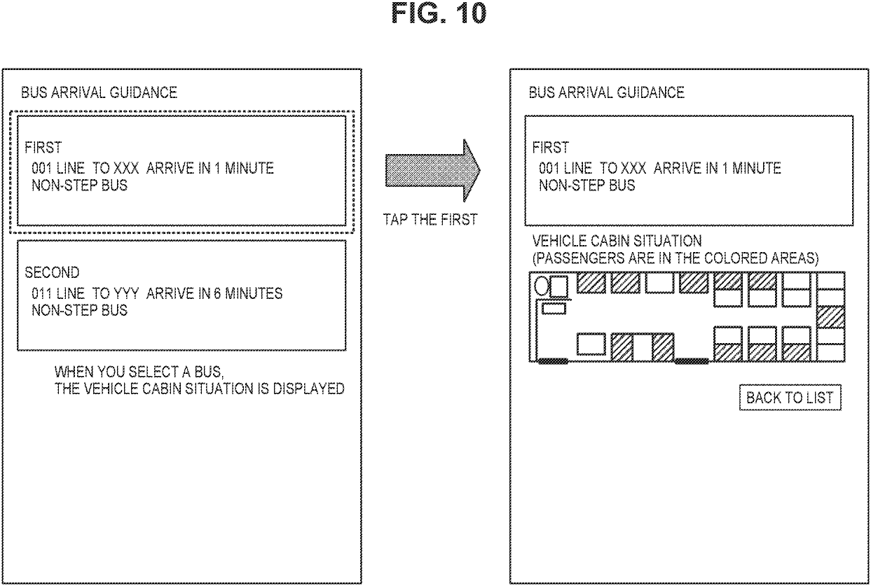

FIG. 10 is an example of an image generated by the image display unit 3011 based on the guidance data illustrated in FIG. 7. The image display unit 3011 generates an image as illustrated in FIG. 10 based on the guidance data, and outputs it via the input/output unit 304. When the guidance data includes data on the buses, the image display unit 3011 generates an image containing information on the buses. In addition, when the arrival time is represented by the remaining time, the image display unit 3011 may check, calculate and update the time display.

Further, the image display unit 3011 can generate an image representing the vehicle cabin situation based on the vehicle cabin data. For example, when the passenger selects (for example, taps inside the dotted line) a vehicle via the input/output unit 304, the image display unit 3011 generates and outputs an image that provides guidance on the situation in the vehicle cabin based on the vehicle cabin data corresponding to the selected vehicle. For example, when the situation in the vehicle cabin is a seating situation, the image display unit 3011 may generate an image as illustrated in FIG. 10. In addition, when the situation in the vehicle cabin is a sitting and standing situation, the image display unit 3011 may generate an image as illustrated in FIG. 11.

In addition, in the present embodiment, the image display unit 3011 generates an image representing the distribution of passengers in the vehicle cabin based on the vehicle cabin data, but the image display unit 3011 may generate an image containing other information. For example, the image display unit 3011 can also generate an image that provides guidance on a place at which a wheelchair, a stroller, or the like can be loaded, or a seat that has a device for fixing a wheelchair, a stroller, or the like. Therefore, the server device 200 may include detailed information about the vehicle in the guidance data.

The storage unit 302 includes a main storage device and an auxiliary storage device. The main storage device is a memory in which programs executed by the control unit 301 and data used by the control program are developed. The auxiliary storage device is a device in which programs executed in the control unit 301 and data used by the control program are stored.

The communication unit 303 is a communication interface for connecting the signage 300 to a network. The communication unit 303 includes, for example, a network interface board and a wireless communication interface for wireless communication.

The input/output unit 304 is a device for inputting/outputting information. Specifically, the input/output unit 304 is composed of a display 304A and its control means, and a touch panel 304B and its control means. A touch panel and a display consist of one touch panel display in the present embodiment. The input/output unit 304 may include a unit (amplifier or speaker) that outputs voice. The input/output unit 304 can output images via the display 304A and accept input via the touch panel 304B.

The configurations illustrated in FIGS. 2, 5, and 9 are examples, and all or part of the functions illustrated in the figures may be performed using a specially designed circuit. In addition, the program may be stored or executed by a combination of a main storage device and an auxiliary storage device other than those illustrated in the figures.

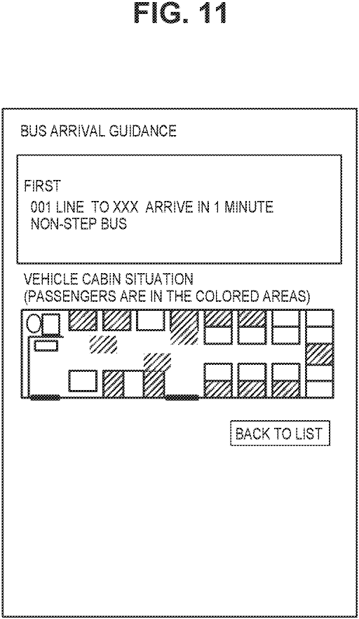

Next, a flowchart of processing executed by each device will be described. FIG. 12 is a sequence diagram of processing in which the in-vehicle device 100 and the server device 200 transmit and receive vehicle data. The illustrated process is repeatedly executed at a predetermined cycle while the vehicle 10 is traveling.

First, in step S11, the data transmission unit 1011 determines whether a predetermined transmission cycle has arrived. When a predetermined cycle (for example, every one minute) arrives, the process transitions to step S12. When the predetermined cycle has not yet arrived, the process is repeated after waiting for a predetermined period of time. In step S12, the data transmission unit 1011 generates vehicle data. As described above, the data transmission unit 1011 generates vehicle data including operation-related data and vehicle cabin data. As described above, the operation-related data can be acquired via operation-related equipment mounted on the vehicle 10 or the position information acquisition unit 105. The vehicle cabin data can also be acquired via the sensor 104.

The generated vehicle data is transmitted to the server device 200 in step S13. In step S14, the server device 200 (data collection unit 2011) receives the vehicle data transmitted from the in-vehicle device 100 and stores it in the storage unit 202.

As a result, vehicle data received from the vehicles 10 is accumulated in the storage unit 202 of the server device 200 as needed.

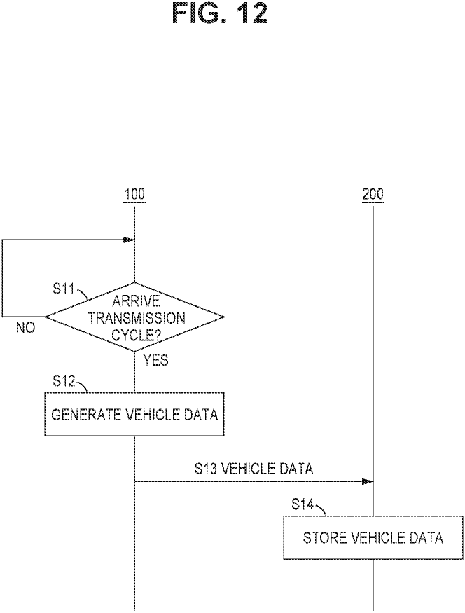

FIG. 13 is a sequence diagram of processing by which the server device 200 transmits guidance data to the signage 300. The illustrated process is repeatedly executed at a predetermined cycle while the fixed-route bus is traveling.

First, in step S21, the signage control unit 2012 determines whether a predetermined transmission cycle has arrived. When a predetermined cycle (for example, every one minute) arrives, the process transitions to step S22. When the predetermined cycle has not yet arrived, the process is repeated after waiting for a predetermined period of time. In step S22, the signage control unit 2012 generates guidance data for each signage 300.

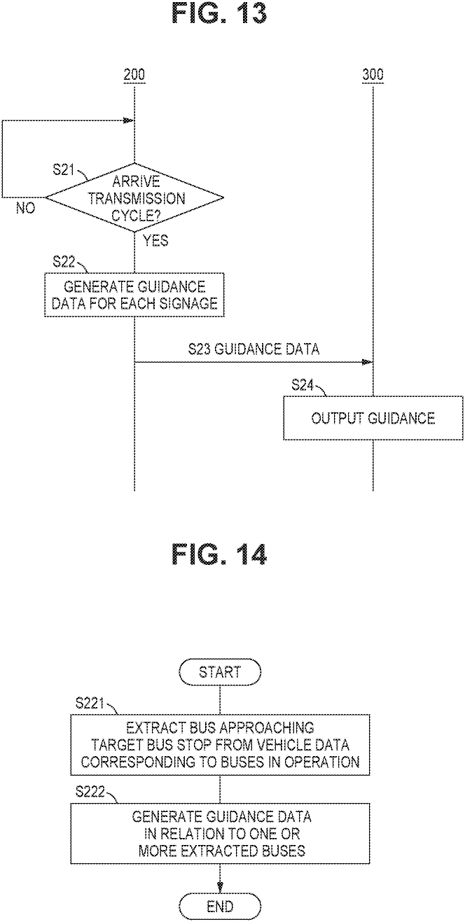

FIG. 14 is a flowchart of processing executed by the signage control unit 2012 in step S22. The illustrated processing is executed for each of the signages 300. First, in step S221, data indicating buses approaching the target bus stop are extracted from vehicle data corresponding to buses in operation. Extraction can be performed based on the vehicle data 202A, the signage data 202B, and the route data 202C. In particular, the route to which the target bus stop belongs is specified, and among the buses traveling on the route, the buses approaching the target bus stop within a predetermined distance (for example, within three stops) or within a predetermined period of time (for example, three minutes) are extracted. Next, in step S222, guidance data as illustrated in FIG. 7 is generated based on the vehicle data corresponding to the one or more extracted buses.

The generated guidance data is transmitted to the target signage 300 in step S23. When there is a plurality of target signages 300, the signage control unit 2012 transmits guidance data to each of the target signages 300.

In step S24, the control unit 301 (image display unit 3011) of each signage 300 generates image data based on the received guidance data and outputs it to the input/output unit 304. As illustrated in FIG. 10, when outputting a plurality of images, the control unit 301 may switch the images to be output based on the operation performed on the touch panel. In the example of FIG. 10, for example, when the first bus is selected, an image (an image representing the vehicle cabin situation) corresponding to the first arriving bus is displayed, and when the second bus is selected, an image (an image representing the vehicle cabin situation) corresponding to the next arriving bus is displayed.

As described above, in the system according to the first embodiment, the buses transmit data on the vehicle cabin situations to the server device 200, and the server device 200 distributes this to the signages 300. The signage 300 outputs an image obtained by visualizing the vehicle cabin situation of the target bus based on the distributed data. Passengers waiting for the bus can thus obtain information about the vehicle cabin situation of the arriving bus in advance, and it becomes possible to plan actions (for example, which seat to sit in) after boarding in advance.

In the present embodiment, the signage 300 generates image data based on the guidance data generated by the server device 200, but the guidance data may be image data generated by the server device 200. In this case, the image display unit 3011 may execute processing to output the received image data via the input/output unit 304, which will be described below.

In addition, in the present embodiment, an example of guiding the distribution of people in the vehicle cabin is given, but when the people alighting from the vehicle at the target bus stop can be estimated, the result of the estimation may be output via the signage 300. For example, when a stop button provided on the vehicle 10 is pushed, it can be estimated that a person near the stop button will alight from the vehicle at the next bus stop. In such a case, it is also possible to output guidance to the effect that nearby seats may become available.

### Second Embodiment

A second embodiment is an embodiment in which the signage 300 acquires information about passengers boarding at a bus stop and notifies the vehicle 10 of the information via the server device 200.

FIG. 15 is a schematic diagram of a vehicle system according to the second embodiment. In the present embodiment, the signage 300 has the function of outputting images based on guidance data, as well as the function of acquiring data on passengers who are scheduled to board based on operations performed using the touch panel, and transmitting the data to the server device 200. The data on a passenger who is scheduled to board includes, for example, data indicating that a passenger is accompanied by a wheelchair or a stroller, or that the passenger needs some assistance.

When the server device 200 receives the data, it identifies the vehicle 10 that the passenger is scheduled to board, and transfers the data to the in-vehicle device 100 mounted on the vehicle 10. In addition, based on the received data, the in-vehicle device 100 notifies the vehicle cabin that a passenger requiring assistance is boarding. This allows the bus crew to recognize that a passenger requiring assistance is scheduled to board.

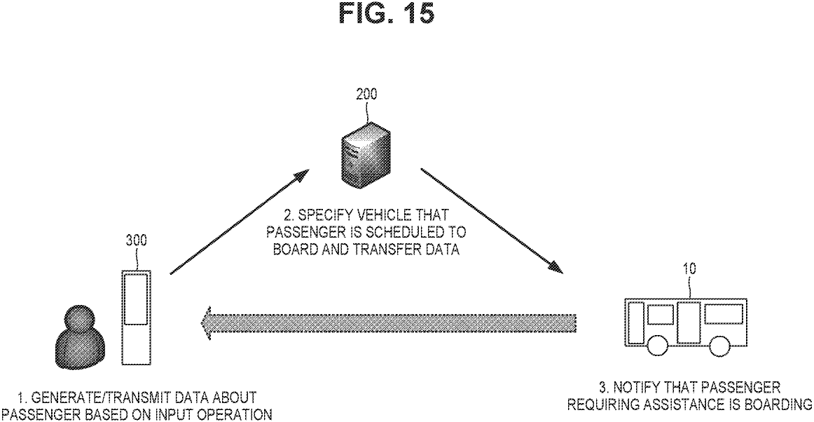

FIG. 16 is a diagram illustrating in detail the components of the signage 300 in the second embodiment. The present embodiment differs from the first embodiment in that the control unit 301 of the signage 300 further has an information acquisition unit 3012.

The information acquisition unit 3012 acquires information designating the vehicle 10 to be boarded and details of necessary assistance from a passenger who is scheduled to board the bus. These pieces of information are called passenger information. For example, as illustrated in FIG. 10, when the signage 300 can display the vehicle cabin situation for each vehicle, an interface for inputting passenger information may be added to the screen displaying the vehicle cabin situations.

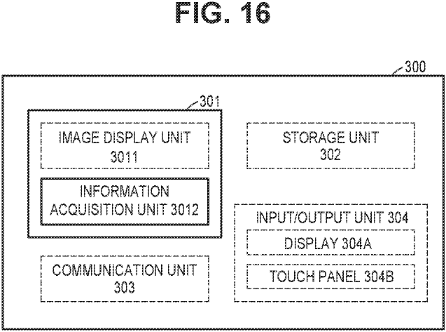

FIG. 17 is an example of an interface for inputting passenger information. In this example, three buttons (wheelchair, stroller, and other assistance) are displayed on the screen, any of which can be pressed. When the passenger presses any button, the information acquisition unit 3012 generates data (hereinafter referred to as passenger data) for providing a notification regarding the details of necessary assistance, and transmits the data to the server device 200.

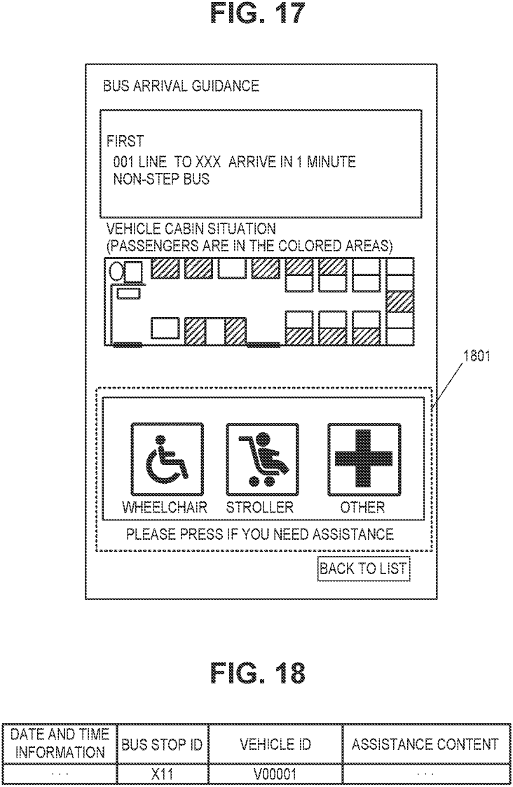

FIG. 18 is an example of passenger data generated by the information acquisition unit 3012. As illustrated, the passenger data includes fields for date and time information, bus stop ID, vehicle ID, and assistance content. The date and time information field stores the date and time when the passenger data was generated. The bus stop ID field stores the identifier of the bus stop at which the signage 300 that transmitted the passenger information is installed. The vehicle ID field stores the identifier of the specified vehicle. The assistance content field stores the content (wheelchair, stroller, or the like) of the desired assistance.

Passenger data transmitted from the signage 300 is received by the server device 200. FIG. 19 is a diagram illustrating in detail the components of the server device 200 in the second embodiment. As illustrated, the present embodiment differs from the first embodiment in that the control unit 201 of the server device 200 further has a transfer unit 2013.

The transfer unit 2013 receives passenger data transmitted from the signage 300. In addition, based on the received passenger data, the bus (vehicle 10) which the passenger declared he/she wishes to board is specified. The vehicle 10 (in-vehicle device 100) which the passenger is scheduled to board can be identified by the vehicle ID included in the passenger data. In addition, the transfer unit 2013 transfers the passenger data to the in-vehicle device 100 mounted on the specified vehicle 10.

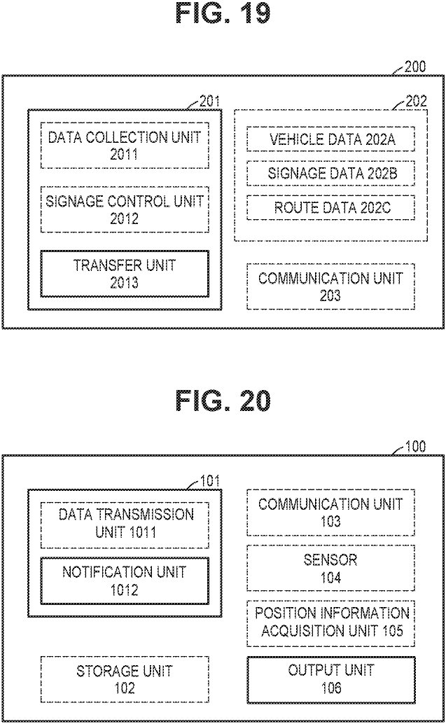

The passenger data transferred by the server device 200 is received by the in-vehicle device 100. FIG. 20 is a diagram illustrating in detail the components of the in-vehicle device 100 in the second embodiment. As illustrated, the present embodiment differs from the first embodiment in that the control unit 101 of the in-vehicle device 100 further has a notification unit 1012. In addition, the in-vehicle device 100 differs from the first embodiment in that it further has an output unit 106.

The notification unit 1012 receives the passenger data transferred from the server device 200. Further, based on the received passenger data, the notification unit 1012 notifies the bus crew via the output unit 106 of “the bus stop at which the target passenger is scheduled to board” and “content of necessary assistance”. The notification may be made visually, or may be made by voice or the like. The output unit 106 is a unit that outputs information, and includes, for example, a display device and a voice output device. When operation-related equipment is mounted on the vehicle 10, the output unit 106 may cooperate with the equipment to output images, voice, and the like.

FIG. 21 is an example of a screen output by operation-related equipment. The operation-related equipment includes, for example, a monitor device installed near the driver’s seat. Information (current time, bus stop to be passed, scheduled time of passage, presence or absence of boarding or alighting, and the like) on operation is normally output to the monitor device. In this example, in an area corresponding to the bus stop (X3) at which the target passenger is scheduled to board, a display indicating that a passenger requiring assistance is scheduled to board is output. This allows the bus crew to recognize that a passenger requiring assistance is boarding.

In the present embodiment, an example is provided in which a passenger who needs assistance when boarding the bus provides the content of the request, but the information to be transmitted to the target bus may be information other than information related to assistance. For example, a passenger who needs some assistance when boarding the vehicle may declare that the passenger needs assistance.

Further, in the present embodiment, the notification is provided to the crew of the bus, but the notification may be provided to the passengers of the bus. For example, an announcement may be output requesting that a space be secured for a wheelchair or a stroller.

Furthermore, in the present embodiment, an example is provided in which the passenger inputs information via the signage 300, but the passenger information may be acquired by other methods. For example, the signage 300 may acquire passenger information by communicating with a mobile terminal owned by the passenger. For example, the mobile terminal may transmit passenger information by short-range wireless communication, and the nearby signage 300 may receive it. With such a configuration, it is possible to automatically notify the inside of the bus of information on passengers.

### Third Embodiment

A third embodiment is an embodiment in which the vehicle 10 is a bus having a maximum seating capacity, and the server device 200 provides a seat reservation service for the bus.

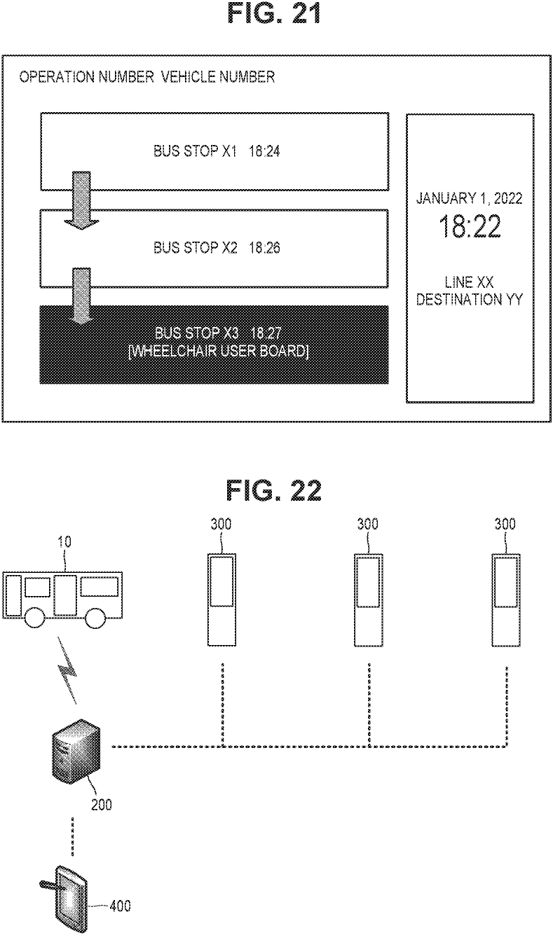

FIG. 22 is a schematic diagram of a vehicle system according to the third embodiment. As illustrated, in the present embodiment, the server device 200 is configured to be able to communicate with a user terminal 400. The user terminal 400 is a terminal used by passengers on the bus. In the third embodiment, the server device 200 provides a seat reservation function in addition to the functions described in the first embodiment.

FIG. 23 is a system configuration diagram of the server device 200 according to the third embodiment. As illustrated, the server device 200 (control unit 201) according to the third embodiment differs from the first embodiment in that it further has a reservation reception unit 2014. The reservation reception unit 2014 communicates with the user terminal 400 and executes seat reservation for the bus. The server device 200 stores a reservation ledger (reference numerals and letters 202D) in the storage unit 202, and can accept reservations based on the data. The reservation ledger 202D stores the vehicle (operation number) to be reserved, the content of the reservation, the passenger’s personal information, and the like.

In a system that accepts seat reservations online, passengers must access the reservation system in advance and take prescribed measures. In the third embodiment, convenience is improved by enabling passengers to access the reservation system via the signage 300 installed at the bus stop.

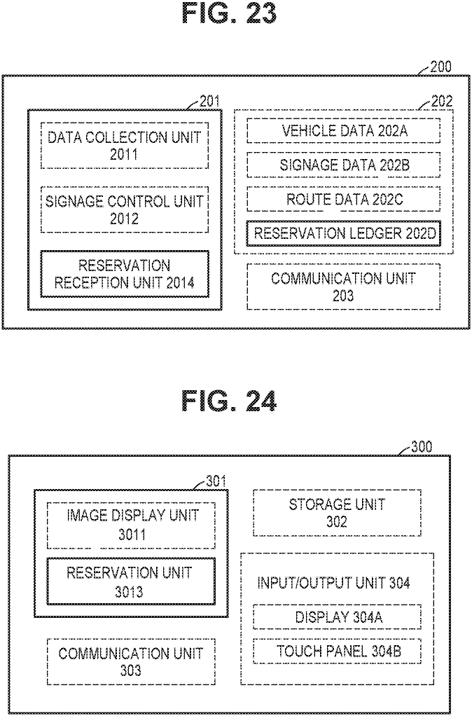

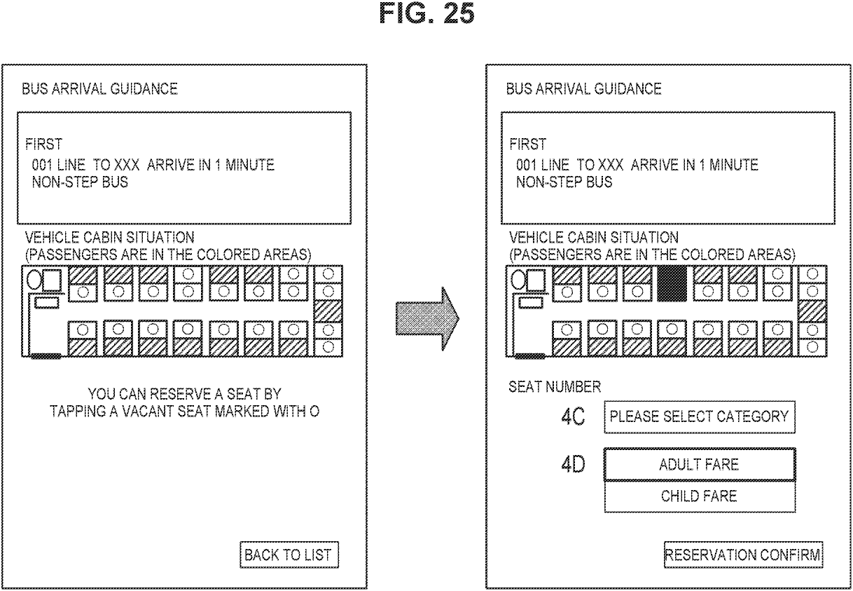

FIG. 24 is a diagram illustrating in detail the components of the signage 300 in the third embodiment. As illustrated, the present embodiment differs from the first embodiment in that the control unit 301 of the signage 300 further has a reservation unit 3013.

The reservation unit 3013 acquires information on seat reservations from passengers who are scheduled to board the bus. For example, as illustrated in FIG. 10, when the signage 300 can display the vehicle cabin situations for each vehicle, an interface for inputting reservation information may be added to the screen displaying the vehicle cabin situations.

FIG. 25 is an example of an interface for inputting reservation information. In this example, an empty seat can be pressed. When a passenger presses any seat, the reservation unit 3013 collects information necessary for reservation and generates reservation data based on the information. The information necessary for reservation is, for example, a passenger’s identifier, the age (fare category) of the person who will board the bus, and the like.

In addition, in the example illustrated in FIG. 25, the reservation information is acquired via the touch panel of the signage 300, but the reservation information may be acquired from the mobile terminal owned by the passenger. For example, the reservation unit 3013 may transmit a URL or the like for inputting reservation information to the mobile terminal and acquire the reservation information via the network. The URL or the like may be transmitted to the mobile terminal by wireless communication, or may be read by the mobile terminal using a two-dimensional code or the like. The reservation unit 3013 generates reservation data based on the acquired reservation information and transmits it to the server device 200.

When the reservation reception unit 2014 of the server device 200 receives the reservation data from the signage 300, it reflects the content of the reservation on the reservation ledger 202D and transmits the data about the reservation to the vehicle 10 (in-vehicle device 100). This allows the bus crew to recognize that a new seat reservation has been made.

The reservation unit 3013 may acquire information on fare payment together with the reservation information and settle the fare. For example, the reservation unit 3013 may output a two-dimensional code for performing electronic payment and cause the mobile terminal to perform electronic payment. In this case, the reservation unit 3013 may generate reservation data after a condition that payment is completed is satisfied. As such, the signage 300 may be configured to be able to communicate with a server device that performs electronic payments.

### Modification Example

The embodiments described above are merely examples, and the present disclosure can be modified and implemented as appropriate without departing from the gist of the present disclosure. For example, the processes and means described in the present disclosure can be freely combined and implemented as long as there no technical contradiction occurs.

In the description of the embodiments, the signage 300 outputs the graphic representing the situation of the vehicle cabin, but the image of the vehicle cabin itself may be output. In this case, the vehicle cabin data may include an image captured by a vehicle-mounted camera. Furthermore, the image of the vehicle cabin may be a moving image. In this case, streaming may be performed from the in-vehicle device 100 to the signage 300 via the server device 200.

In the description of the embodiments, the server device 200 controlling a plurality of signages 300 is exemplified, but each of the signages 300 may perform the functions of the server device 200. That is, the control unit 201 and the control unit 301 may be realized by the same hardware. In this case, each of the signages 300 may be configured to be communicable with the in-vehicle device 100 and the server device 200 may be omitted.

In addition, the processes described as being performed by one device may be shared and performed by a plurality of devices. Alternatively, the processes described as being performed by different devices may be performed by one device. In the system, it is possible to flexibly change the hardware configuration (server configuration) to implement each function.

The present disclosure can also be realized by supplying a computer program implementing the functions described in the above embodiments to a computer, and reading and executing the program by one or more processors of the computer. Such a computer program may be provided to the computer by a non-transitory computer-readable storage medium connectable to the system bus of the computer, or may be provided to the computer via a network. A non-transitory computer-readable storage medium includes, for example, any type of disk, such as a magnetic disk (floppy (registered trademark) disk, hard disk drive (HDD), or the like) and an optical disk (CD-ROM, DVD disk, Blu-ray disk, or the like), a read only memory (ROM), a random access memory (RAM), an EPROM, an EEPROM, a magnetic card, a flash memory, an optical card, and any type of medium suitable for storing electronic instructions.

What is claimed is:

1. An information processing device comprising a controller configured to:
acquire first data about a vehicle cabin situation from a vehicle that is a fixed-route bus; and
output a guidance image generated based on the first data via a signage device installed at a bus stop at which the vehicle stops.

2. The information processing device according to claim 1, wherein the first data includes information on a seat occupancy situation or passenger distribution in the vehicle.

3. The information processing device according to claim 1, wherein the controller is configured to output, via the signage device, an image obtained by visualizing the vehicle cabin situation based on the first data.

4. The information processing device according to claim 1, wherein the controller is configured to output the guidance image corresponding to the vehicle designated by a user when the first data is acquired from a plurality of vehicles.

5. The information processing device according to claim 1, wherein the controller is configured to output the guidance image corresponding to the vehicle via the signage device installed at a bus stop to which the vehicle approaches so as to be within a predetermined distance.

6. The information processing device according to claim 5, wherein the controller is configured to output the guidance image corresponding to the vehicle via the signage device installed at a bus stop at which the vehicle arrives within a predetermined time.

7. The information processing device according to claim 1, wherein the controller is configured to acquire information on a passenger boarding at the bus stop via a touch panel of the signage device.

8. The information processing device according to claim 7, wherein the controller is configured to transmit the information on the passenger to an in-vehicle device mounted on the vehicle.

9. The information processing device according to claim 8, wherein the information on the passenger includes whether the passenger uses a stroller or a wheelchair.

10. The information processing device according to claim 8, wherein the information on the passenger includes a request to reserve a seat.

11. The information processing device according to claim 10, wherein the controller is configured to acquire the request via the touch panel of the signage device.

12. The information processing device according to claim 10, wherein the controller is configured to acquire the request from a user terminal.

13. A vehicle system comprising:
a first device mounted on a vehicle that is a fixed-route bus; and
a second device configured to control a signage device installed at a bus stop, wherein:
the first device has a first controller configured to transmit first data about a vehicle cabin situation to the second device; and
the second device has a second controller configured to output a guidance image generated based on the first data via the signage device installed at the bus stop at which the vehicle stops.

14. The vehicle system according to claim 13, wherein:
the first device includes a sensor configured to sense a vehicle cabin of the vehicle; and
the first device is configured to transmit the first data including a result of the sensing to the second device.

15. The vehicle system according to claim 13, wherein the first data includes information on a seat occupancy situation or passenger distribution in the vehicle.

16. The vehicle system according to claim 13, wherein the second controller is configured to output, via the signage device, an image obtained by visualizing the vehicle cabin situation based on the first data.

17. The vehicle system according to claim 13, wherein the second controller is configured to output the guidance image corresponding to the vehicle via the signage device installed at a bus stop to which the vehicle approaches so as to be within a predetermined distance.

18. The vehicle system according to claim 13, wherein the second controller is configured to acquire information on a passenger boarding at the bus stop via a touch panel of the signage device.

19. The vehicle system according to claim 18, wherein the second controller is configured to transmit the information on the passenger to the first device.

20. The vehicle system according to claim 19, wherein the first controller is configured to notify a vehicle cabin of the vehicle regarding the information on the passenger.
